(19) United States
(12) Patent Application Publication
(10) Pub. No.: US 2025/0245873 A1
(43) Pub. Date: Jul. 31, 2025

(54) GENERATIVE INTERACTIVE ENVIRONMENTS

(71) Applicants: DeepMind Technologies Limited, London (GB); GDM Holding LLC, Mountain View, CA (US)

(72) Inventors: Jacob Bruce, London (GB); Michael David Dennis, London (GB); Ashley Deloris Edwards, London (GB); Jack William Thadeus Parker-Holder, London (GB); Yuge Shi, London (GB); Edward Fauchon Hughes, Hereford (GB); Matthew Lai, London (GB); Aditi Ashutosh Mavalankar, London (GB); Richard Anton Steigerwald, London (GB); Konrad Zolna, London (GB); Scott Ellison Reed, Marietta, GA (US); Karol Gregor, London (GB); Tim Rocktäschel, London (GB)

(21) Appl. No.: 19/041,971

(22) Filed: Jan. 30, 2025

Related U.S. Application Data
(60) Provisional application No. 63/627,019, filed on Jan. 30, 2024.

(51) Int. Cl. G06T 11/00

(52) U.S. Cl. CPC G06T 11/00; G06T 2200/24

(57) ABSTRACT

Methods, systems, and apparatus, including computer programs encoded on computer storage media, for generating controllable videos using generative neural networks.

### CROSS-REFERENCE TO RELATED APPLICATION

This application claims priority to U.S. Provisional Application No. 63/627,019, filed on Jan. 30, 2024. The disclosure of the prior application is considered part of and is incorporated by reference in the disclosure of this application.

### BACKGROUND

This specification relates processing data using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that generates controllable videos using a set of generative neural networks.

Particular embodiments of the subject matter described in this specification can be implemented so as to realize one or more of the following advantages.

The techniques described in this specification generate videos that are referred to as “controllable” videos because any given video is controllable on a frame-by-frame basis through an action space that includes a set of actions. That is, by specifying different actions, an interactive agent, e.g., a (human) user, the video generation system, or an external system, can cause different video frames to be generated, thereby “controlling” the video generation process. Moreover, the interactive agent can “seed” the generation of the video by submitting one or more context inputs that define one or more initial video frames from the video. For example, the user or other interactive agent can provide the one or more initial video frames. As another example, the user or other interactive agent can provide a different context input, e.g., a text input, an audio signal, an initial image, or some combination. Thus, the interactive agent can control not only how the video progresses, but also, by providing the context input(s), the visual content that is initially depicted in the video and that will be modified as the video progresses.

Thus, an interactive agent can, as a result of the described techniques, cause the system to generate videos that depict a variety of action-controllable virtual worlds described through any of a variety of context inputs, e.g., text, synthetic images, photographs, and even sketches.

Moreover, the described techniques enable users to act in the generated environments on a frame-by-frame basis despite the generative neural networks that are used to generate the videos being trained without any ground-truth action labels or other domain-specific requirements.

Further, the learned latent action space facilitates training agents to imitate behaviors from unseen videos, resulting in improved training of generalist agents.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example video generation system.

FIG. 2 shows an example of the operation of the video generation system.

FIG. 3 is a flow diagram of an example process for generating a video frame.

FIG. 4 shows an example of the operations of the system when generating a video frame.

FIG. 5 shows an example of the video encoder neural network and the video decoder neural network.

FIG. 6 shows an example of the dynamics neural network.

FIG. 7 shows an example of the ST-Transformer architecture.

FIG. 8 shows an example of the training of the dynamics neural network.

FIG. 9 is a flow diagram of an example process for controlling an agent using latent actions.

Like reference numbers and designations in the various drawings indicate like elements.

### DETAILED DESCRIPTION

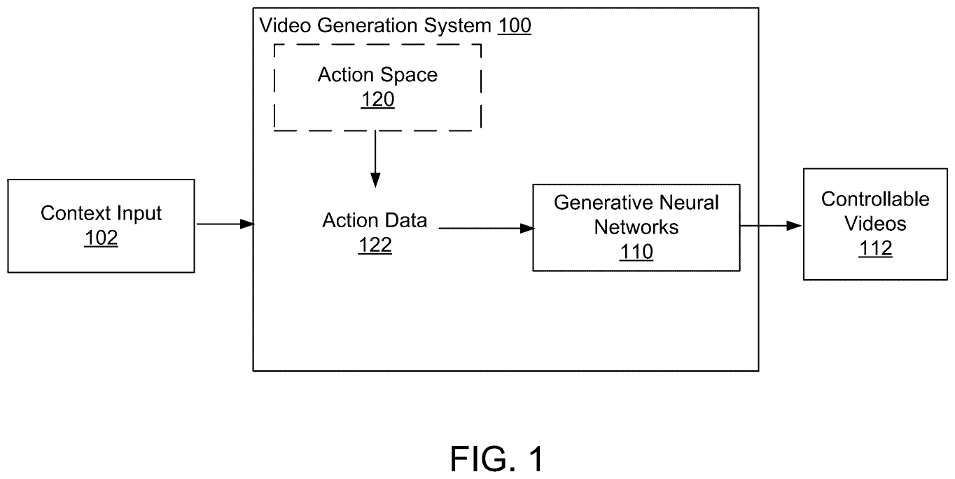

FIG. 1 shows an example video generation system 100. The video generation system 100 is an example of a system implemented as computer programs on one or more computers in one or more locations, in which the systems, components, and techniques described below can be implemented.

The system 100 generates controllable videos 112 using a set of generative neural networks 110.

The videos 112 generated by the system 100 are referred to as “controllable” videos because any given video 112 is controllable on a frame-by-frame basis through an action space 120 that includes a set of actions. That is, control of the generation of the video 112 is performed by (e.g., a human user or another computer system) selecting action(s) from the action space. For example, the actions in the action space 120 can be, e.g., learned, latent actions that have been learned through training. As a particular example, the set of actions can include a fixed, discrete number of learned, latent actions.

In particular, the selection of a different action as of a given frame in the video 112 defines the transition between the given frame and the next frame in the video 112. In other words, selecting a different action for a given frame will cause the system 100 to generate a different next frame in the video 112.

Therefore, the system 100 implements a “generative interactive environment” framework in which interactive environments can be initialized randomly or from a context input (“prompt”) 102 and then “controlled” using the set of actions in the action space 120.

In particular, the “controllable” videos 112 generated by the system 100 each have a respective video frame corresponding to each of a sequence of time points.

To generate the video frame corresponding to a given time point, the system obtains action data 122 selecting an action from the space of actions 120.

For example, a user can submit an input selecting the action through a user interface, e.g., through a user interface that displays the video 112 as of the given time point. Thus, the user can serve as an “interactive agent” that controls the generation of the video 112.

Alternatively, the interactive agent can be an automated agent that, e.g., randomly selects actions from the set or that selects actions using another criterion.

In some implementations, the system 100 receives an input selecting an action at each time point.

In some other implementations, the system 100 may only receive inputs at a proper subset of the time points in the video. In these implementations, if no input is received, the system 100 can select the action selected by the most recently received input or select an action at random from the set.

The system 100 then generates the next video frame conditioned on the action data 122 using the generative neural networks 110. In some implementations, as will be described below, the set of generative neural networks 110 generally includes at least a dynamics neural network that predicts tokens representing a given video frame and a video decoder neural network that generates the given video frame.

Generating video frames using the generative neural networks 110 will be described in more detail below.

In order to “seed” the generation of the video 112, the video 112 will generally also include one or more initial video frames preceding the video frames corresponding to the sequence of time points that are not generated using the generative neural networks 110 conditioned on actions.

For example, the user or other interactive agent can provide, as the context input 102, the one or more initial video frames (and, optionally, when there are multiple initial video frames, an action that was selected between any two consecutive video frames).

As another example, the user or other interactive agent can provide a different context input 102, e.g., a text input, an audio signal, an initial image, or some combination.

The system 100 can then process the one or more context inputs using an image generation neural network to generate the one or more initial video frames. For example, the image generation neural network can be a pre-trained conditional image diffusion neural network or a different type of image generation neural network.

Thus, the interactive agent can control not only how the video progress, but also, by providing the context input(s) 102, the visual content that is initially depicted in the video and that will be modified as the video progresses.

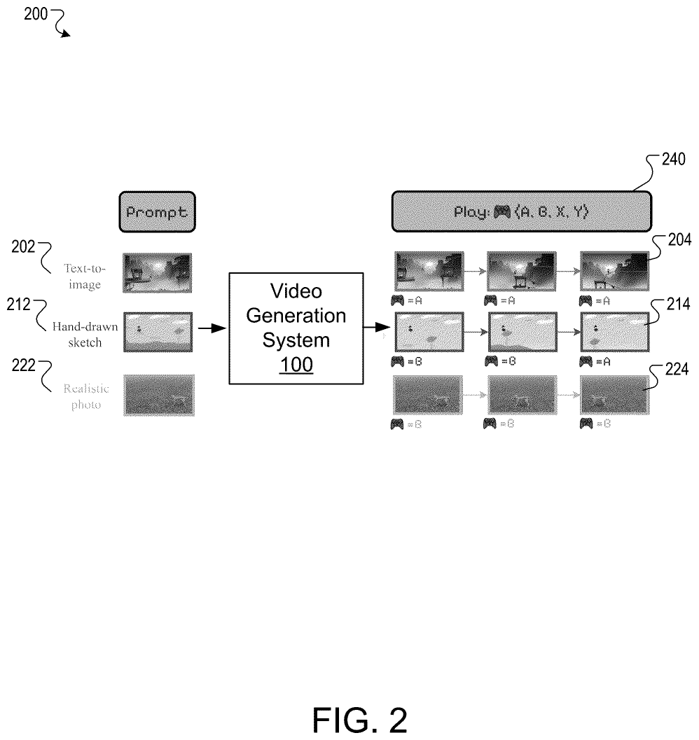

FIG. 2 shows an example 200 of the operation of the video generation system 100.

As shown in the example 200, the system 100 can receive any of a variety of context inputs (“prompts”) and use any given one of the prompts to generate a video.

For example, the system 100 can receive a text context input and then map the text context input to at least one initial video frame 202 using a text-to-image generative neural network. The system can then process the initial video frame(s) 202 to generate a video 204 that starts from the initial video frame(s) 202.

As another example, the system 100 can receive a hand-drawn sketch and then use the hand-drawn sketch as at least one initial video frame 212. The system can then process the initial video frame(s) 212 to generate a video 214 that starts from the initial video frame(s) 212.

As another example, the system 100 can receive at least one realistic photo, e.g., at least one photo (e.g., a video) of the real-world captured by a camera device, and then use the realistic photo(s) as at least one initial video frame 222 (e.g., a sequence of video frames that show motion of objects in a real world environment imaged by the camera device). The system can then process the at least one initial video frame 222 to generate a video 224 that starts from the initial video frame(s) 222. In this way, a realistic simulation of a real-world environment (imaged in the initial video frame(s)) can be generated, including a prediction of the response of the real-world environment to any actions performed by an agent interacting with the environment by performing the selected actions.

For example, using the system 100 a user who wishes to determine the consequences in the environment of an agent interacting with the environment, can realistically simulate a video of the evolution of the environment in the case that the agent performs action(s), e.g., actions selected by the user. This process may be repeated multiple times, each time determining the consequences in the environment of the agent performing different corresponding actions, so that an (e.g., optimal) set of actions can be selected, to bring the environment as close as possible (according to a similarity metric) to a desired state of the environment.

As an example, the initial video frame(s) may show a real world environment including multiple entities which evolve with time, such as objects which are on fire in an environment (e.g., a room of a building) which is itself on fire, and the actions may include motions the agent should perform in the environment to escape from the environment safely and/or actions the agent should perform to achieve some other objective, e.g., to remove valuable objects from the environment.

As described above, as part of making the generated videos “controllable” the system conditions the generation of each video frame on a selected action from a space of actions 240. In the example 240, the space of actions 240 include a discrete set of four latent actions, represented as the actions A, B, X, and Y. When generating any given one of the videos 204-224, the system conditions the generation of each of the video frames on one of the actions from the discrete set. For example, the system can receive user inputs specifying the actions or can randomly select the actions.

As shown in FIG. 2, the system generates the video 204 conditioned on the action sequence A, A, A, generates the video 214 conditioned on the action sequence B, B, A, and generates the video 224 conditioned on the action sequence B, B, B. Starting from the same initial video frame but conditioning on a different sequence of actions generally results in a different video being generated by the system.

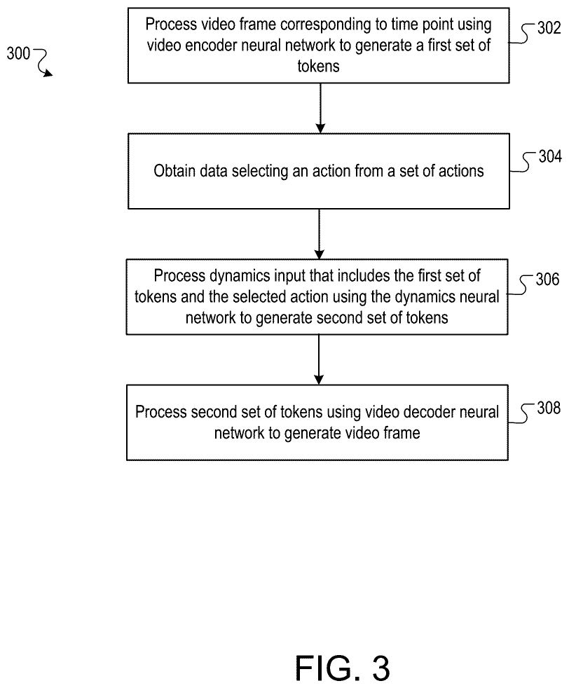

FIG. 3 is a flow diagram of an example process 300 for generating a video frame in a video. For convenience, the process 300 will be described as being performed by a system of one or more computers located in one or more locations. For example, a video generation system, e.g., the video generation system 100 of FIG. 1, appropriately programmed, can perform the process 300.

In particular, to generate a video, the system performs the process 300 at each of a sequence of time points in the video to generate the video frame at the time point.

As described above, in order to “seed” the generation of the video, the video will generally also include one or more initial video frames preceding the video frames corresponding to the sequence of time points that are not generated by performing the process 300.

For example, the user or other interactive agent can provide the one or more initial video frames (and, optionally, when there are multiple initial video frames an action that was selected between any two consecutive video frames).

As another example, the user or other interactive agent can provide a different context input, e.g., a text input, an audio signal, an initial image, or some combination. The system can then process the one or more context inputs using an image generation neural network to generate the one or more initial video frames. For example, the image generation neural network can be a pre-trained conditional image diffusion neural network or a different type of image generation neural network.

Thus, the interactive agent can control not only how the video progress, but also, by providing the context input(s), the visual content that is initially depicted in the video and that will be modified as the video progresses.

The system processes at least the video frame corresponding to the time point using a video encoder neural network to generate a first set of tokens representing the video as of the time point (step 302).

In some implementations, the first set of tokens is also conditioned on the video frames at one or more time points preceding the given time point in the sequence. That is, the system processes not only the video frame corresponding to the time point but also the video frames at any earlier time points using the video encoder neural network to generate the first set of tokens representing the video.

A “token,” as used in this specification, is a vector of numerical values having a fixed dimensionality. In some implementations, the tokens are each selected from a discrete set of tokens.

The video encoder neural network will be described in more detail below.

The system obtains data selecting an action from a set of actions (step 304). As described above, the actions can be learned, latent actions that have been learned during training. For example, as will be described below, the actions can be learned during the training of a latent action model.

In some implementations, the set of actions is a discrete set. That is, the set of actions can include only a fixed, discrete number of learned, latent actions. That is, while the latent vectors in the set are learned during the training of the latent action model, the total number of latent vectors in the set is fixed to a set number throughout the training.

For example, a user can submit an input selecting the action through a user interface, e.g., through a user interface that displays the video as of the given time point. Thus, the user can serve as an “interactive agent” that controls the generation of the video.

Alternatively, the interactive agent can be an automated agent that, e.g., randomly selects actions from the set or that selects actions using another criterion.

In some implementations, the system receives an input (e.g., from a human user or another system) selecting an action at each time point.

In some other implementations, the system may only receive inputs at a proper subset of the time points in the video. In these implementations, if no input is received, the system can select the action selected by the most recently received input or select an action at random from the set.

The system processes a dynamics input that includes the first set of tokens and the selected action using a dynamics neural network to generate a second set of tokens representing a video frame at a next time point in the sequence in the sequence given that the selected action is performed at the time point (step 306).

In some implementations, the dynamics input can also include selected actions that were selected when generating the video frame at the given time point and, further optionally, the video frames at one or more preceding time points in the sequence.

In some implementations, the dynamics input includes a vector from a codebook of vectors representing the selected action while, in other implementations, the dynamics input includes an identifier that uniquely identifies the selected action.

The system then processes at least the second set of tokens using a video decoder neural network to generate the video frame at the next time point in the sequence (step 308).

Thus, because selecting a different action can cause different second sets of tokens to be generated, selecting different actions will generally cause the video frame at the next time point in the sequence to contain different visual content, allowing the user or other interactive agent to control the generation of the video by selecting actions.

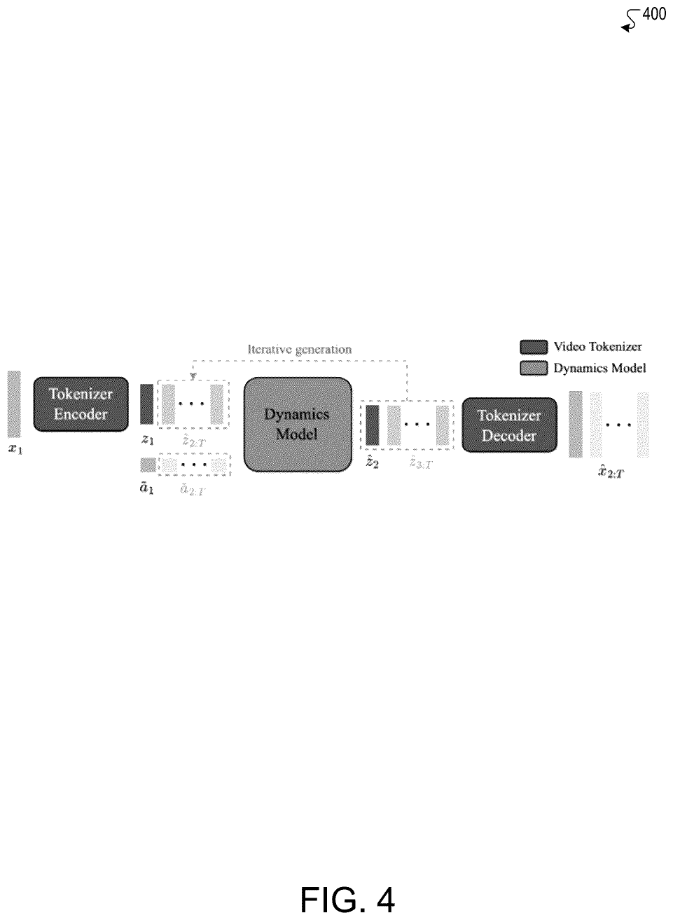

FIG. 4 shows an example 400 of the operation of the system when generating a video frame.

As shown in FIG. 4, the system receives an initial video frame x₁. The system processes the initial video frame x₁ using the video encoder neural network to generate a set of tokens z₁ representing the initial video frame x₁.

The system then performs iterative generation, i.e., performs multiple iterations of the process 300, to generate video frames \hat{x}₂ through î_{T} conditioned on the set of tokens z₁ representing the initial video frame x₁.

For example, as shown in FIG. 4, to generate the next frame \hat{x}₂, the system processes a dynamics input that includes the set of tokens z₁ representing the initial video frame x₁ and data identifying an action ã₁ from the space of actions using the dynamics neural network to generate a set of tokens \hat{z}₂ representing the video frame \hat{x}₂ at a next time point in the sequence in the sequence given that the action ã₁ is performed at the time point.

In some implementations, the dynamics input includes a vector from a codebook of vectors representing the action ã₁ while in other implementations the dynamics input includes an identifier that uniquely identifies the selected action ã₁. In these other implementations, the dynamics neural network can map the identifier to an embedding of the action that the dynamics neural network then processes further as part of generating the set of tokens \hat{z}₂.

An example of the processing performed by the dynamics neural network to generate the set of tokens \hat{z}₂ will be described in more detail below.

The system then processes at least the set of tokens \hat{z}₂ using the video decoder neural network (shown in FIG. 4 as the “tokenizer decoder”) to generate the video frame \hat{x}₂. This process is iterated, such that at each of times t=1, . . . , T−1, the dynamics neural network processes at least zₜ and ãₜ to generate \hat{z}ₜ₊₁, using which the video decoder neural network generates \hat{x}ₜ₊₁.

In the example 400, the dynamics input when generating any given video frame (e.g., the video frame at time t′, denoted \hat{x}_{t′+1}) includes the sets of tokens representing the preceding video frames, i.e., the set of tokens z₁ representing the initial video frame x₁ and the corresponding sets of tokens (e.g., zₜ for t=2, . . . t′) representing any already generated video frames, as well as the corresponding actions (e.g., ãₜ for t=1, . . . t′) for each already generated video frame. Alternatively, the dynamics input when generating any given video frame may include only a subject of the sets of tokens represented the preceding video frames (e.g., for t′ greater than a value T1, it may include only the sets of video tokens for the preceding T1 frames; for t′ lower than or equal to T1, it may include the sets of video tokens for all preceding frames) and/or only a subset of the preceding actions (e.g., for t′ greater than a value T2, it may include only the actions for the preceding T2 frames; for t′ lower than or equal to T2, it may include the actions for all preceding frames).

Similarly, the input to the video decoder neural network includes the sets of tokens representing the given video frame and the sets of tokens representing the already generated video frames.

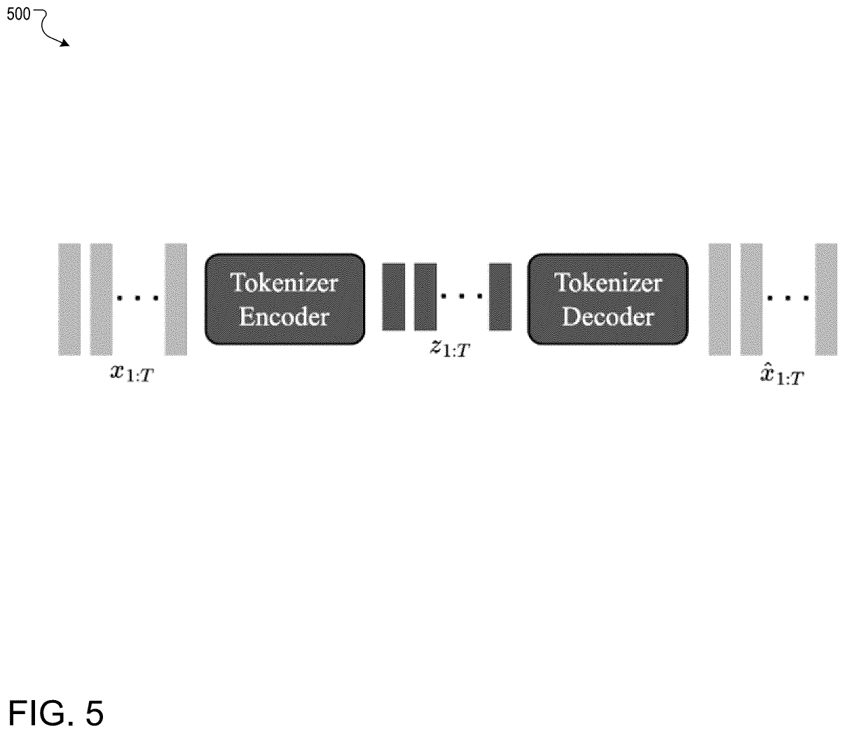

FIG. 5 shows an example 500 of the video encoder neural network and the video decoder neural network.

In the example of FIG. 5, the video encoder neural network (“tokenizer encoder”) is a causally masked neural network that generates the first set of tokens for a given video frame at a given time point conditioned on the given video frame corresponding to the time point and any video frames at any preceding time points in the sequence.

As a particular example, the video encoder neural network can include a Transformer neural network that includes a plurality of spatial-temporal attention blocks that each include at least one spatial attention layer and at least one causally masked temporal attention layer. This type of neural network is also referred to as an ST-transformer neural network.

An example of the architecture of such a neural network is described below.

Thus, when given as input video frames x₁ through x_{T} from a given video, the video encoder neural network generates sets of tokens z₁ through z_{T}, where the set of tokens zₜ is dependent only on the video frames x₁ through xₜ and not on video frames xₜ₊₁ through x_{T}.

As indicated above, in some implementations, the set of tokens for a given video frame generated by the video encoder neural network are selected from a discrete set of tokens. In these examples, the Transformer neural network can be followed by a quantization layer that quantizes each (continuous) token generated by the Transformer to one of a discrete set of tokens. The tokens in the discrete set are learned jointly with the training of the video encoder neural network, as will be described in more detail below.

Similarly, in the example of FIG. 5, the video decoder neural network (“tokenizer decoder”) is a causally masked neural network that generates the video frame at the next time point in the sequence conditioned on the second set of tokens and respective first sets of tokens representing the video frame at the time point and any video frames at any preceding time points in the sequence.

As a particular example, the video decoder neural network can also be an ST-Transformer neural network, i.e., the video decoder neural network can be a Transformer neural network that includes a plurality of spatial-temporal attention blocks that each include at least one spatial attention layer and at least one causally masked temporal attention layer.

Thus, when given as input sets of tokens z₁ through z_{T}, the video decoder neural network generates predicted video frames \hat{x}₂ through \hat{x}_{T}, where the predicted video frame \hat{x}ₜ is dependent only on the tokens z₁ through zₜ and not on the tokens zₜ₊₁ through z_{T}.

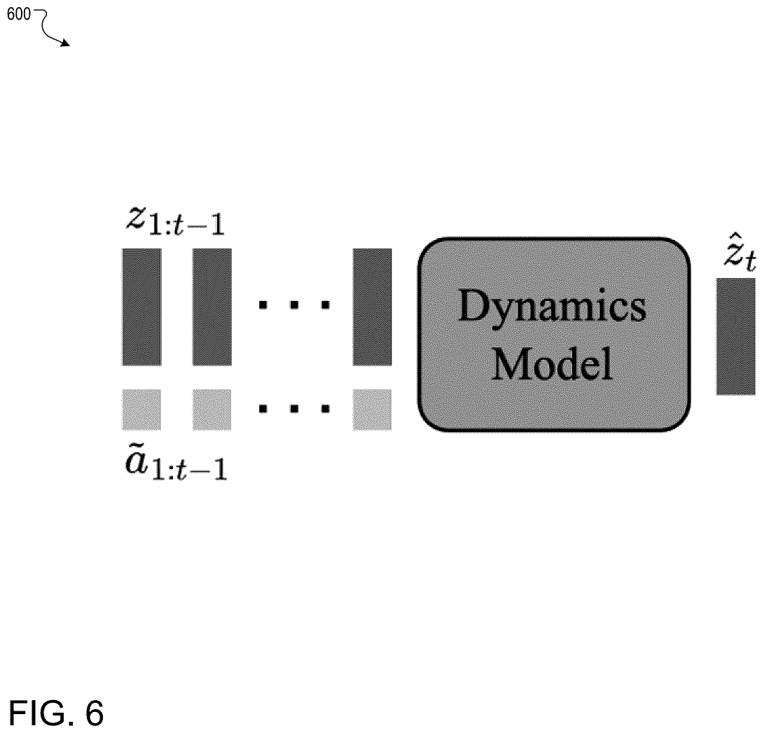

FIG. 6 shows an example 600 of the dynamics neural network.

As shown in the example 600, when generating a set of tokens zₜ, the dynamics neural network receives a dynamics input that includes the sets of tokens z₁ through zₜ₋₁ along with the corresponding actions ã₁ through ãₜ₋₁ and processes the dynamics input to generate the set of tokens zₜ.

That is, in the example 600, when generating the set of tokens for the “next” time step, the dynamics input includes not only the first set of tokens representing the video frame at the current time step and the selected action at the current time step, but also, for each of one or more video frames at one or more preceding time steps, (i) a respective first set of tokens representing the video frame and (ii) a selected action at the preceding time step.

For example, when generating the set of tokens for the next time step, the dynamics neural network can, for the current time step and the one or more preceding time steps, augment the first set of tokens representing the video frame corresponding to the time step using the selected action at the time step to generate an augmented dynamics input and then process the augmented dynamics input to generate the next set of tokens.

“Augmenting” a set of tokens using a selected action generally refers to combining the set of tokens with data representing the selected action.

For example, the system can augment the set of tokens by adding an embedding of the selected action elementwise with the first set of tokens representing the video frame. The embedding of the selected action can be, e.g., learned, during the training of the dynamics neural network. Performing this elementwise addition can improve the controllability of the generated videos, e.g., relative to alternative ways of incorporating the action into the generation of the output tokens.

The dynamics neural network can generally have any appropriate architecture that allows the neural network to map the (augmented) dynamics input to a set of tokens. For example, the dynamics neural network can be a masked generative image Transformer. As a particular example of this, the masked generative image Transformer can have the ST-Transformer architecture.

When the set of tokens for a given video frame generated by the video encoder neural network are selected from a discrete set of tokens, the tokens generated by the dynamics neural network are also selected from the discrete set. In these examples, the Transformer neural network can be followed by a quantization layer that quantizes each (continuous) token generated by the Transformer to one of the discrete set of tokens.

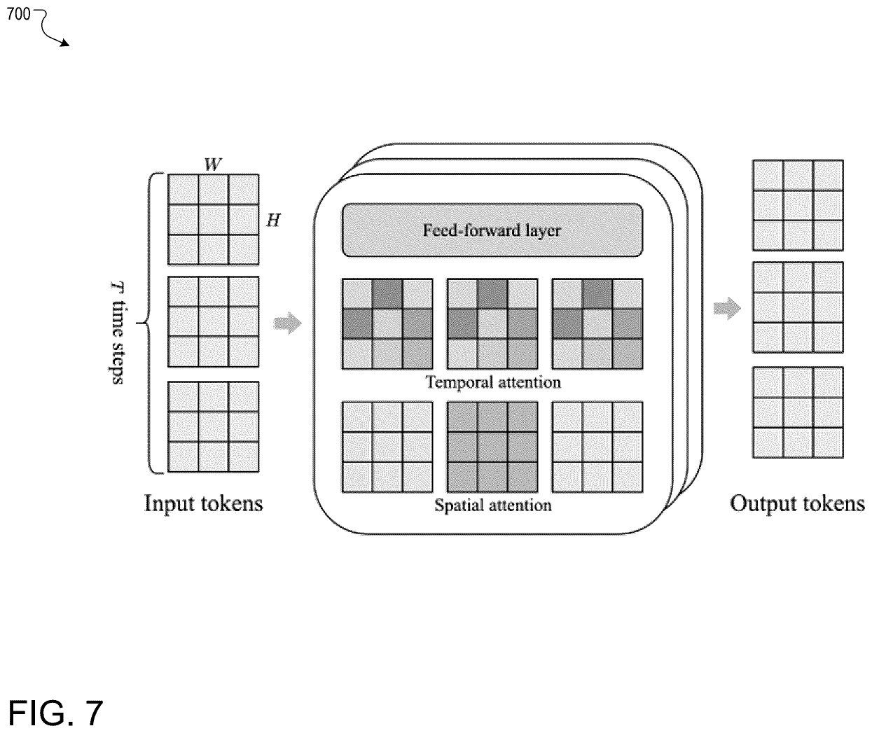

FIG. 7 shows an example 700 of the ST-Transformer architecture. As described above, in some examples one or more of the video encoder neural network, the video decoder neural network, the dynamics neural network, or the latent action encoder can have the described architecture. In some cases, different neural networks have different architectures, while, in some cases, all of the neural networks above can have the same architecture.

As shown in the example 700, the architecture receives an input that includes an H×W set of input tokens for each of T time steps. The architecture processes the input to generate an output that includes a set of output tokens for each of the T time steps.

The architecture includes a plurality of spatial-temporal attention blocks that each include at least one spatial attention layer and at least one causally masked temporal attention layer. In the example 700, each spatial-temporal block also includes a feed-forward layer (FFW) that updates each token independently of the other tokens.

The self-attention in the spatial layer attends over the 1×H×W tokens within each time step, and the self-attention in the temporal layer attends over T×1×1 tokens across the T time steps. That is, the temporal layer attends over the same token from all T time steps. In other words, for a given token at a given location H1×W1 in the set of input tokens at a given time step T1, the temporal layer attends over all tokens at location H1×W1 at all of the T time steps, and not over any tokens at any other locations. The temporal layer assumes a causal structure with a causal mask so that the token at time step t attends only to the tokens from time steps 1 through t and not to the tokens at time steps t+1 through T.

Thus, the dominating factor of computation complexity (i.e., the spatial attention layer) in the architecture scales linearly with the number of frames rather than quadratically, making it much more efficient for video generation with consistent dynamics over extended interactions. Further, note that the architecture includes only one FFW after both spatial and temporal components, omitting the post-spatial FFW to allow for scaling up other components of the model, which can lead to improved performance. The FFW receives each token after having been updated by the spatial and temporal layers and processes each token independently through one or more feed-forward network layers, e.g., through a multi-layer perceptron (MLP), through a gated linear unit (GLU), and so on, to further update the token to generate the output of the spatial-temporal block. The spatial-temporal block can optionally include other components, e.g., before the spatial and temporal layers, between the spatial and temporal layers, before the FFW, after the FFW, and so on. Examples of such other components include residual connections, normalization layers, and so on.

Prior to using the generative neural networks, i.e., the video encoder neural network, the video decoder neural network, and the dynamics neural network, to generate controllable videos, the system or another training system trains the generative neural networks in the set, i.e., trains the video encoder neural network, the video decoder neural network, and the dynamics neural network. For example, the generative neural networks can be trained on an unsupervised video data set, i.e., a data set of videos that are not annotated with any ground truth action labels. In other words, the unsupervised video data set does not include any text or action labels.

In some cases, the system can generate the unsupervised video data set. For example, the system can obtain an initial unsupervised video data set that includes a plurality of initial training videos.

The system can process each of the plurality of initial training videos using a video classifier neural network to classify a quality of the initial training video, and then determine whether to include each of the plurality of initial training videos in the unsupervised video data set based on the classification of the initial training video. That is, the system can include, in the unsupervised video data set, only initial training videos that have at least a threshold level of quality, ensuring that the training video set includes videos that provide a high quality training signal.

Generally, the training system trains the video encoder and video decoder neural networks jointly on a video reconstruction objective on the unsupervised video data set. For example, when the tokens used to represent videos are discrete, the video reconstruction objective can be a Vector Quantised-Variational AutoEncoder (VQ-VAE) objective that jointly trains the video encoder and video decoder neural networks and learns the codebook that includes the discrete video tokens. VQ-VAE objectives are described in more detail in van den Oord, et al, Neural Discrete Representation Learning, arXiv:1711.00937.

After the video encoder and video decoder neural networks have been trained, the system can learn the discrete set of actions by training a latent action model on the unsupervised video data set on a video reconstruction task.

Generally, the latent action model maps an input video to an output that includes, for a given pair of frames from the video, a latent action vector that represents an action performed to cause the video to transition from the first video frame in the pair to the second video frame in the pair.

As a particular example, the latent action model can include a latent action encoder that is configured to process a latent action input that includes a sequence of video frames. The sequence of video frames includes a training video frame at a particular time point in a training video and a training video frame at a subsequent time point in the training video.

The latent action encoder processes the latent action input to generate a latent action vector that represents an action performed at the particular time point to cause the training video to transition from the training video frame at the particular time point to the training video frame at the subsequent time point. Thus, the latent action model has access to “privileged” information in the form of the subsequent video frame and generates an output that “explains” the transition from the particular time point to the subsequent time point.

When the latent actions are discrete, the latent action model further includes a vector quantization layer that quantizes the latent action vector to one of the discrete set of latent vectors. The latent vectors in the discrete set are learned jointly with the training of the latent action model on the unsupervised video data set.

For example, the training system can train the latent action model jointly with a pixelwise video frame decoder that receives as input at least the quantized latent action vector and the training video frame at the particular time point and generates a reconstruction of the training video frame at the subsequent time point. The system can then train the pixelwise video frame decoder and the latent action model jointly on an objective that measures a reconstruction quality of the reconstruction of the training video frame. When the latent actions are discrete, the system also learns the codebook of latent vectors as part of this training, e.g., using a VQ-VAE objective.

The system also trains the dynamics neural network on the unsupervised video data set on a video token prediction task using the video encoder neural network and the latent action model.

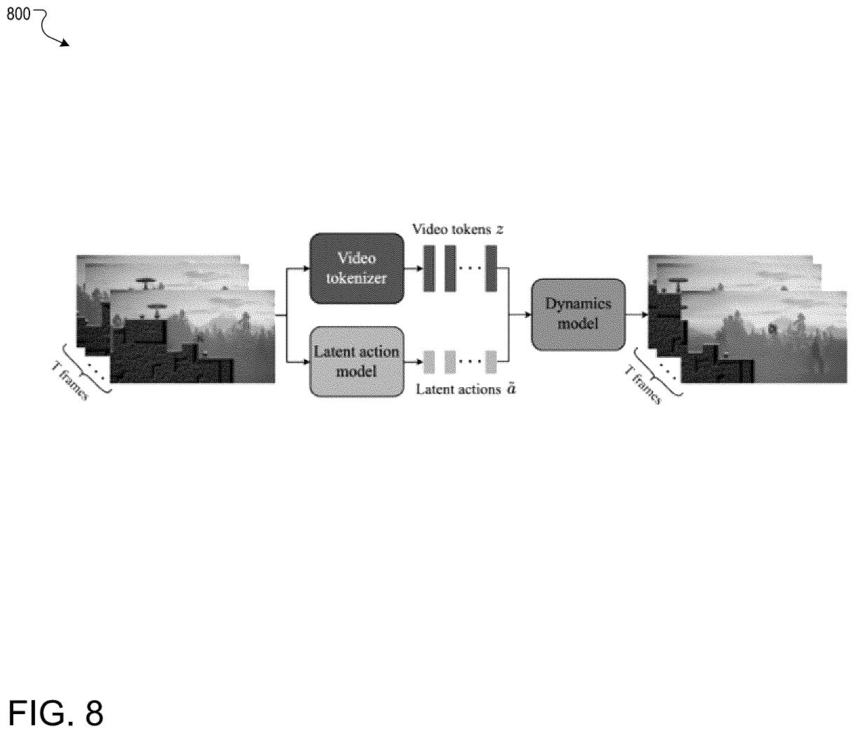

FIG. 8 shows an example 800 of the training of the dynamics neural network.

As shown in FIG. 8, the system receives a training video and processes the training video using the video encoder neural network to generate a set of video tokens for each of the video frames in the training video.

The system also processes the training video using the latent action model to generate a respective latent action for each frame in the video (other than the last frame).

The system then processes the sets of video tokens and the latent actions as described above using the dynamics neural network to generate a respective set of predicted tokens for each video frame in the video (other than the first frame).

The system can then train the dynamics neural network on a loss function, e.g., a cross-entropy loss, that measures an error between, for at least some of the frames, the predicted tokens for the video frame and the actual video tokens for the video frame.

While the above description has described generating videos using latent actions, instead of or in addition to using the latent actions to generate videos, the system can use the learned latent actions to control an agent interacting with an environment by selecting control inputs to be used to control the agent. For example, the agent can be a robot being controlled to perform a task in the environment.

In more detail, in some implementations, the environment is a real-world environment and the agent is a mechanical agent interacting with the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The control inputs may be control inputs to control a robot, e.g., torques for the joints of the robot or higher-level control commands, or the autonomous or semi-autonomous land or air or sea vehicle, e.g., torques to the control surface or other control elements of the vehicle or higher-level control commands.

In other words, the control inputs can include for example, position, velocity, or force/torque/acceleration data for one or more joints of a robot or parts of another mechanical agent. Control inputs may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the control inputs may include actions to control navigation, e.g., steering, and movement e.g., braking and/or acceleration of the vehicle.

In some implementations the environment is a simulated environment and the agent is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the control inputs may be control inputs to control the simulated user or simulated vehicle. As another example, the simulated environment may be a computer simulation of a real-world environment and the agent may be a simulated robot interacting with the computer simulation.

Generally, when the environment is a simulated environment, the control inputs may include simulated versions of one or more of the previously described control inputs or types of control inputs.

In some cases, the system can be used to control the interactions of the agent with a simulated environment, and the system can train the parameters of the policy neural network used to control the agent based on the interactions of the agent with the simulated environment. After the policy neural network is trained based on the interactions of the agent with a simulated environment, the trained policy neural network can be used to control the interactions of a real-world agent with the real-world environment, i.e., to control the agent that was being simulated in the simulated environment. Training the neural network based on interactions of an agent with a simulated environment (i.e., instead of a real-world environment) can avoid wear-and-tear on the agent and can reduce the likelihood that, by performing poorly chosen actions, the agent can damage itself or aspects of its environment.

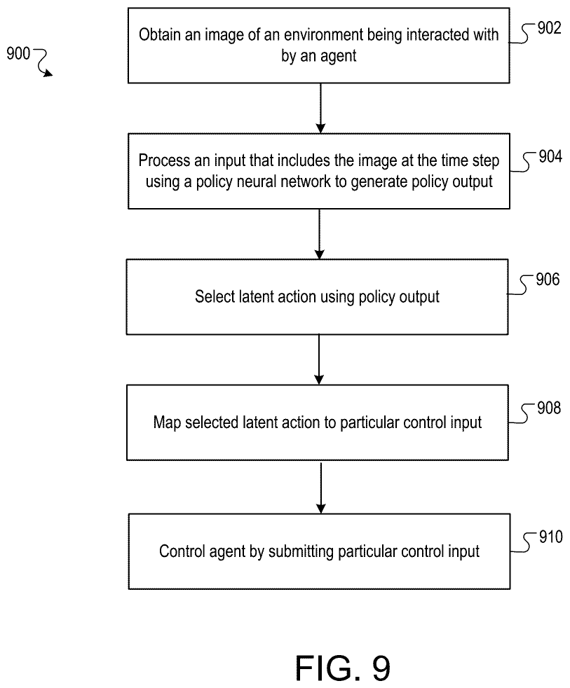

FIG. 9 is a flow diagram of an example process 900 for controlling an agent using learned latent actions. For convenience, the process 900 will be described as being performed by a system of one or more computers located in one or more locations. For example, a video generation system, e.g., the video generation system 100 of FIG. 1, appropriately programmed, can perform the process 900.

The system can perform the process 900 at each of a sequence of time steps in order to control the agent.

The system obtains an image of an environment being interacted with by an agent (step 902). Generally, the agent is controllable by a set of control inputs.

The system processes an input that includes the image at the time step using a policy neural network to generate a policy output that assigns a respective probability to each of a set of latent actions (step 904).

As described above, the learned, latent actions can have been learned by training a latent action model on an unsupervised video data set.

For example, the policy neural network can have been trained through imitation learning on trajectories generated by processing sequences of images using the trained latent action model to identify a latent action performed by the agent in each image in the sequence. That is, the policy neural network can be trained to predict, by processing a given image (and optionally one or more preceding images in the sequence), the latent action that was generated by processing the given image and a subsequent image using the latent action model. Examples of imitation learning objectives that can be used to perform this training include behavior cloning and inverse reinforcement learning.

The system selects a latent action using the policy output (step 906). For example, the system can select the action with the highest probability or can sample a latent action in accordance with the probabilities in the policy output.

The system maps the selected latent action to a particular control input from the set of control inputs (step 908).

That is, the system maintains data that defines a mapping between latent actions and control inputs in the set of control inputs, i.e., data that maps each latent action to a respective one of the control inputs to the agent.

For example, the system can generate the mappings using a dataset with expert ground-truth actions. In particular, the system can obtain a dataset that includes a set of action-labeled expert sequences, with each expert sequence including a first image, a second image, and a labeled control input that was performed to cause the environment to transition from the state in the second image from the state in the first image. The labels can be generated, e.g., by a human user or by controlling the agent using an existing policy, e.g., a random policy, a heuristic-based policy, or an already-trained policy neural network.

For each expert sequence, the system can use the trained latent action model to determine the latent action that caused the transition from the second image to the first image.

The system can then fill a dictionary D consisting of mapped latents to a list of corresponding real control inputs using the correspondence between the latent actions and the ground truth control inputs in the expert sequences.

The system controls the agent by submitting the particular control input (step 910).

Thus, the trained latent action model can be used as a “foundation” model that is used to train multiple different task-specific policy neural networks for controlling different agents in different environments to perform various tasks. In particular, the trained latent action model can be used to bootstrap the training of multiple different policy neural networks without needing to re-train the latent action model.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in Al and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for generating a controllable video, the video comprising a respective video frame corresponding to each of a sequence of time points, and the method comprising, for each of the sequence of time points:
processing at least the video frame corresponding to the time point using a video encoder neural network to generate a first set of tokens representing the video as of the time point;
obtaining data selecting an action from a set of actions;
processing a dynamics input comprising the first set of tokens and the selected action using a dynamics neural network to generate a second set of tokens representing a video frame at a next time point in the sequence in the sequence given that the selected action is performed at the time point; and
processing at least the second set of tokens using a video decoder neural network to generate the video frame at the next time point.

2. The method of claim 1, wherein each token in the first set of tokens and in the second set of tokens is a respective token from a discrete set of tokens.

3. The method of claim 1, wherein the video encoder neural network is a causally masked neural network that generates the first set of tokens conditioned on the video frame corresponding to the time point and any video frames at any preceding time points in the sequence.

4. The method of claim 3, wherein the video encoder neural network is a Transformer neural network that includes a plurality of spatial-temporal attention blocks that each include at least one spatial attention layer and at least one causally masked temporal attention layer.

5. The method of claim 1, wherein the video decoder neural network is a causally masked neural network that generates the video frame at the next time point in the sequence conditioned on the second set of tokens and respective first sets of tokens representing the video frame at the time point and any video frames at any preceding time points in the sequence.

6. The method of claim 5, wherein the video decoder neural network is a Transformer neural network that includes a plurality of spatial-temporal attention blocks that each include at least one spatial attention layer and at least one causally masked temporal attention layer.

7. The method of claim 1, wherein the set of actions is a discrete set of learned, latent actions.

8. The method of claim 1, wherein obtaining data selecting an action from a set of actions comprises:
receiving a user input selecting an action from the set of actions.

9. The method of claim 1, wherein obtaining data selecting an action from a set of actions comprises:
sampling an action from a distribution over the set of actions.

10. The method of claim 1, wherein the video further comprises one or more initial video frames preceding the video frames corresponding to the sequence of time points.

11. The method of claim 10, further comprising:
obtaining the one or more initial video frames.

12. The method of claim 11, wherein obtaining the one or more initial video frames comprises:
receiving a user input identifying the one or more initial video frames.

13. The method of claim 11, wherein obtaining the one or more initial video frames comprises:
receiving, as user input, one or more context inputs; and
processing the one or more context inputs using an image generation neural network to generate the one or more initial video frames.

14. The method of claim 11 in which the one or more initial video frames are images of a real-world environment captured by a camera device.

15. The method of claim 1, wherein the dynamics input further comprises, for each of one or more video frames at one or more preceding time steps, (i) a respective first set of tokens representing the video frame and (ii) a selected action at the preceding time step.

16. The method of claim 15, wherein processing the dynamics input comprises:
for the time step and the one or more preceding time steps:
augmenting the first set of tokens representing the video frame corresponding to the time step using the selected action at the time step to generate an augmented dynamics input; and
processing the augmented dynamics input using the dynamics neural network.

17. The method of claim 16, wherein augmenting the first set of tokens representing the video frame using the selected action at the time step to generate an augmented dynamics input comprises:
adding an embedding of the selected action elementwise with the first set of tokens representing the video frame.

18. The method of claim 1, wherein the dynamics neural network is a masked generative image Transformer.

19. The method of claim 1, wherein the video encoder and video decoder neural networks have been jointly trained on a video reconstruction objective on an unsupervised video data set.

20. The method of claim 19, wherein the video reconstruction objective is a VQ-VAE objective.

21. The method of claim 19, wherein the set of actions is a discrete set of learned, latent actions, and wherein, after the video encoder and video decoder neural networks have been trained, the learned discrete set of actions is learned by training a latent action model on the unsupervised video data set on a video reconstruction task.

22. The method of claim 21, wherein the latent action model comprises:
a latent action encoder that is configured to process a latent action input that comprises a sequence of video frames that comprises a training video frame at a particular time point in a training video and a training video frame at a subsequent time point in the training video and to generate a latent action vector that represents an action performed at the particular time point to cause the training video to transition from the training video frame at the particular time point to the training video frame at the subsequent time point.

23. The method of claim 22, wherein the latent action model further comprises a vector quantization layer that quantizes the latent action vector to one of the discrete set of latent vectors, and wherein the latent vectors in the discrete set are learned jointly with the training of the latent action model on the unsupervised video data set.

24. The method of claim 23, wherein the latent action model is trained jointly with a pixelwise video frame decoder that receives as input at least the quantized latent action vector and the training video frame at the particular time point and generates a reconstruction of the training video frame at the subsequent time point.

25. The method of claim 19, wherein, after the video encoder and video decoder neural networks have been trained, the dynamics neural network is trained on the unsupervised video data set on a video token prediction task.

26. The method of claim 19, wherein the unsupervised video data set does not include any text or action labels.

27. The method of claim 19, wherein the unsupervised video data set is generated by obtaining an initial unsupervised video data set that comprises a plurality of initial training videos, processing each of the plurality of initial training videos using a video classifier neural network to classify a quality of the initial training video, and determining whether to include each of the plurality of initial training videos in the unsupervised video data set based on the classification of the initial training video.

28. A method performed by one or more computers, the method comprising, at each of a plurality of time steps:
obtaining an image of an environment being interacted with by an agent, wherein the agent is controllable by a set of control inputs;
processing an input comprising the image at the time step using a policy neural network to generate a policy output that assigns a respective probability to each of a set of latent actions;
selecting a latent action using the policy output;
mapping the selected latent action to a particular control input from the set of control inputs; and
controlling the agent by submitting the particular control input.

29. The method of claim 28, wherein the learned, latent actions have been learned by training a latent action model on an unsupervised video data set.

30. The method of claim 29, wherein the policy neural network has been trained through imitation learning on trajectories generated by processing sequences of images using the trained latent action model to identify a latent action performed by the agent in each image in the sequence.

31. A system comprising one or more computers and one or more storage devices storing instructions that are operable, when executed by the one or more computers, to cause the one or more computers to perform operations for generating a controllable video, the video comprising a respective video frame corresponding to each of a sequence of time points, and the operations comprising, for each of the sequence of time points:
processing at least the video frame corresponding to the time point using a video encoder neural network to generate a first set of tokens representing the video as of the time point;
obtaining data selecting an action from a set of actions;
processing a dynamics input comprising the first set of tokens and the selected action using a dynamics neural network to generate a second set of tokens representing a video frame at a next time point in the sequence in the sequence given that the selected action is performed at the time point; and
processing at least the second set of tokens using a video decoder neural network to generate the video frame at the next time point.
